(19) United States
(12) Patent Application Publication
(10) Pub. No.: US 2022/0098116 A1
(43) Pub. Date: Mar. 31, 2022

(54) CERAMIC COMPOSITE HEATERS COMPRISING BORON NITRIDE AND TITANIUM DIBORIDE

(71) Applicant: MOMENTIVE PERFORMANCE MATERIALS INC., Waterford, NY (US)

(72) Inventors: Sudarshan NATARAJAN, Solon, OH (US); Wei FAN, Brecksville, OH (US); Xiang LIU, Medina, OH (US); Gregory SHAFFER, Strongsville, OH (US)

(21) Appl. No.: 17/417,876

(22) PCT Filed: Dec. 18, 2019
(86) PCT No.: PCT/US2019/067019

§ 371 Date: Jun. 24, 2021

Related U.S. Application Data
(60) Provisional application No. 62/785,453, filed on Dec. 27, 2018.

(51) Int. Cl. C04B 35/583; C04B 35/58; H05B 3/14

(52) U.S. Cl. CPC C04B 35/583; C04B 35/58071; C04B 2235/386; C04B 2235/3813; H05B 3/14

(57) ABSTRACT

Provided is a ceramic composite including boron nitride (BN) and titanium diboride (TiB₂) for use in 2-D and 3-D heating element applications. The ceramic composite can be used in heater applications without a protective coating. The ceramic composite may be corrosion resistant against oxygen and moisture up to, for example, a temperature of 900° C., and may offer increased corrosion resistance against molten or vapor metal, including aluminum. The ceramic composite may be sufficiently rigid and may not require additional dielectric structural support. The ceramic composite may be sufficiently fracture resistant to enable machining of intricate and complex patterns and designs with a high aspect ratio of the coil length to width or thickness. The ceramic composite may be used with any heater shape, orientation, and size.

### FIELD OF INVENTION

The present disclosure relates generally to a heater and, more particularly, to a heater comprising a ceramic composite material comprising (i) boron nitride (BN) and (ii) a conductive ceramic material, and methods of making such materials. In embodiments the composite material comprises boron nitride and titanium-boride material (e.g., titanium diboride (TiB₂)).

### BACKGROUND

High temperature vacuum processes are utilized in the industrial production of semiconductors, electronics, displays, sensors, solar cells, and the like. High temperature vacuum processes are also used in the chemical, metal, ceramic, and glass processing industry. Metal evaporation, for example, is a common application of high temperature vacuum processes, and can require temperatures upwards of 1200° C. and pressures lower than 10⁻² Torr in order to generally achieve a technically or economically viable process.

Conventional heating element materials used to reach the high temperatures in these vacuum processes often exhibit poor resistance to corrosion by oxygen, nitrogen, hydrogen, moisture, and molten or vapor metal. Conventional heating element materials such as graphite, pyrolytic graphite, refractory metals such as tungsten, molybdenum, and tantalum, carbon fiber composites, and the like, cannot withstand oxygen, nitrogen, hydrogen, or moisture corrosion at temperatures exceeding 400° C. These heating element materials are also susceptible to corrosion through exposure to molten or vapor metals, such as aluminum, which is one of the most commonly used metals for metal evaporation using high temperature vacuum processes.

Due to the poor corrosion resistance to oxygen, nitrogen, hydrogen, moisture, and molten or vapor metal, heating elements incorporating these materials are limited in lifetime operation and operation flexibility. To combat these issues, the heating elements are often coated with ceramics, nitrides, carbides, and the like, and involve more complex engineering that cannot be easily machined. Refractory wires and foils, for example, require dielectric structural support. Even if the heating element materials, such as graphite, can be machined, the needed aspect ratio of the coil length to width or thickness to meet the electrical resistance per unit area specification is difficult to achieve. The protective coatings and designs result in additional costs to produce the heating elements. Further, while protective coatings may prevent corrosion of the heating element material, the protective coatings can also reduce the operating pressure and temperature of the system. Silicon carbide, for example, negatively impacts the system as the silicon evaporates from the coating in vacuum processes. Refractory wires and foils also suffer from brittleness by recrystallization and/or creep and/or warp affecting performance, i.e. temperature uniformity and reliability in a mechanical shock prone environment.

As a result, there is a need for heating element materials that are able to be adequately machined and used in high temperature vacuum processes and other applications without the need for a protective coating. There is a need for heating element materials that are resistant to corrosion by oxygen, nitrogen, hydrogen, moisture, and molten or vapor metal.

### SUMMARY

The following presents a summary of this disclosure to provide a basic understanding of some aspects. This summary is not intended to identify key or critical elements or define any limitations of embodiments or claims. Furthermore, this summary may provide a simplified overview of some aspects that may be described in greater detail in other portions of this disclosure.

Provided is a ceramic composite including (i) boron nitride (BN) and (ii) conductive ceramic material that is a boride, carbide, aluminide, or silicide of a metal for use in 2-D and 3-D heating element applications. The conductive ceramic material may also be considered intermetallic compounds as it is formed of two metals (or a metal and a metalloid).

In one embodiment, the conductive ceramic material is selected from a titanium-boron material. A titanium-boron materials, such as TiB₂, is considered intermetallic as it forms a compound of two metals, titanium and boron, but TiB₂ may also be described as a conductive ceramic. For purposes of this disclosure, the word intermetallic composite and ceramic composite can be used interchangeably. The titanium-boron intermetallic material may include any ratio of titanium to boron as may be suitable. This includes TiB₂ as well as other ratios including, but not limited to TiB_{1.5} to TiB_{3.5}, including ratios in between those values (e.g., TiB_{2.3-3.5}).

The ceramic composite can be used in heater applications including high temperature vacuum processes with or without a protective coating. In addition to high temperature vacuum processes, the ceramic composite may also be used to replace atmospheric heating element alloy materials, such as molybdenum-silicide, nickel-chromium, and iron-chromium-aluminum, which are typically used in atmospheric conditions such as material processing and fuel cells as well as consumer electrical and electronic products such as e-cigarettes, medical equipment, home heating, automotive interior and engine applications, and the like.

The ceramic composite may be corrosion resistant against oxygen, nitrogen, hydrogen, ammonia, and moisture up to, for example, a temperature of about 900° C., and may offer increased corrosion resistance against molten or vapor metal, including aluminum, copper, and tin. The ceramic composite may be sufficiently rigid and may not require additional dielectric structural support. The ceramic composite may be sufficiently fracture resistant to enable machining of intricate and complex patterns and designs with a high aspect ratio of the coil length to width or thickness within a unit area. For instance, the aspect ratio per unit area may be as high as 100 within a square inch of heater surface, up to 60 within a square inch of heater surface, or up to 50 within a square inch of heater surface. In some embodiments, the aspect ratio may range from 5-100 within a square inch, or about 6.5 cm², of heater surface. The width or thickness of the resulting heating element comprising the ceramic composite can be as low as 1 mm and the coil length within a square inch of heater surface can be as high as 100× the width or thickness.

The ceramic composite may be manufactured by hot pressing a blend of BN and the conductive ceramic, as in one embodiment, titanium-boride (e.g., TiB₂), with a sintering aid or binder. The sintering aid or binder may include calcium oxide, other metal oxides chosen from alkaline earth metals, aluminum and its associated compounds such as aluminum nitride, silicon and its associated compounds including silicon carbide or silicon nitride, carbon, metals or metals compounds of transition metals selected from tungsten, titanium, nickel, cobalt, iron, chromium, and the like, and a combination of two or more thereof. The ceramic composite may be machinable and allow for a cost-effective fabrication of complex 2-D and 3-D shapes by Computer Numerical Control (CNC) machining (cutting, lathing, milling, drilling) with diamond tooling. Other material removal techniques such as EDM, laser, water jet, sand blasting, sawing, grinding, and the like may also be used to machine heaters comprising the ceramic composite. The heating rungs can be machined by any machining process to create any desired shape and orientation of the heating rungs, such as a serpentine pattern. The 2-D or 3-D heaters employing the BN/TiB₂ ceramic composite can be coated or can be used in a naked or uncoated form.

The resistance per unit area of the heater may be tuned and manipulated by changing the aspect ratio per unit area and thickness. The ceramic composite may have a high thermal conductivity and low Coefficient of Thermal Expansion (CTE), and a superior thermal shock resistance, for example greater than 200° C./s or greater than 1000° C./min. The ceramic composite may enable realization of high power flux density, such as greater than 10 W/cm², greater than 25 W/cm², or greater than 50 W/cm². In one embodiment, resistivity can also be tuned up or down by decreasing or increasing the TiB₂ ratio or by the addition of a boride, silicide, aluminide, or carbide or other metals from the periodic table. Conductive ceramics such as oxide ceramics and glass may also be used for tuning high temperature resistivity. Non-conductive ceramics, aluminum, and sintering aids and binders may also be used to tune the resistivity. Resistivity of the composite can be varied from 300 MOC (micro ohm cm) to 10000 MOC.

Before or after machining to a final shape of the heater, the heater comprising the ceramic composite may be outgassed or vacuum sintered at a temperature greater than 1800° C. to reduce outgassing and resistance changes during operation of the heater. As a result, the ceramic composite may further enable a resistance per unit area to achieve a power density as high as 60 W/cm² with current under 40 amps at the heater operation temperature of about 1500° C. In addition to vacuum outgassing, the heater including unreacted sintering aids and volatile compounds may be cleaned off by chemical leaching using inorganic or organic acids, bases, or solvents.

The ceramic composite may be used to provide a heater with any shape, orientation, and/or size as desired for a particular application or intended end use. The heater may be provided as a body having generally flat or uniform surfaces (having a substantially solid or block shape when viewed in cross-section), or the heater can be provided with a generally T-shape, generally C-shape, generally U-shape, generally I-shape, or generally H-shape cross-section. These structures may increase the resistance per unit area without compromising the structural strength of the high aspect ratio serpentine patterns of the heaters.

The heater may comprise a plurality of heating rungs. The heating rungs may be substantially horizontal or substantially vertical to a plane. The heating rungs may be substantially parallel or substantially perpendicular to a plane. The heater may include more than one zone or electrode path. A multi-zone heater may have a different power flux density at different locations, achieved by manipulating the aspect ratio of coil length to width or thickness in order to change the resistance per unit area. At least two zones may each comprise a half of the heater or the at least two zones may be adjacent to one another along their lengths. Each heating rung may have the same width or differing widths, and a single heating rung may vary in its width across its length.

In an embodiment, a heater may include a body. The body of the heater may include at least one heating surface, the heating surface being generally smooth and generally flat, a recess formed in the body, at least a portion of the body having a cross-sectional shape selected from the group consisting of: generally T-shape, generally C-shape, generally U-shape, generally I-shape, and generally H-shape, and where the cross-sectional shape extends along at least a portion of the body.

In an embodiment, a heater may comprise an upper surface and a lower surface, and a plurality of heating rungs, where the heating rungs may comprise a major portion oriented horizontal to a plane defined by the upper surface. In an embodiment, a heater may comprise a first surface and a second surface, and a plurality of heating rungs, where the heating rungs may comprise a major portion oriented vertically to a plane defined by the first surface.

In an embodiment, a heater assembly may comprise a body. The body may have a first surface and a second surface. The body may have a configuration defining a predetermined path defining a plurality of heating rungs.

In an embodiment, a body of a heater may further comprise at least two zones or electrode paths. The multi-zone heater may have a different power flux density at different locations. Manipulating the aspect ratio of coil length to width or thickness in order to change the resistance per unit area would result in different power flux densities. In an embodiment, the body may comprise two halves connected in series, where each half has a configuration defining a predetermined path defining a plurality of heating rungs. In an embodiment, the body may comprise a plurality of heating rungs oriented adjacent to one another along their lengths.

In an embodiment, each heating rung may have substantially the same width. In another embodiment, the width of at least one heating rung may be narrower than the width of at least one other heating rung. The width of an uppermost heating rung at a top of an upper surface of the body may be narrower than at least one other heating rung. In another embodiment, the width of the uppermost heating rung at the top of the upper surface of the body is less than or equal to half the width of at least one other heating rung.

### BRIEF DESCRIPTION OF DRAWINGS

Other objects and advantages of the present invention can be understood from the following description when read in conjunction with the accompanying drawings in which:

FIG. 1 shows an embodiment of a heater comprising a ceramic layer in accordance with aspects disclosed herein;

FIG. 2 shows a heater, in which FIG. 2(a) is a partial plan view thereof and FIG. 2(b) is an enlarged cross-section taken along B-B in FIG. 2(a);

FIG. 3 is a plan view of a heater;

FIG. 4 is an enlarged cross-section taken along A-A in FIG. 3;

FIG. 5 is a plan view of a heater embodying a spiral shape;

FIG. 6 is a plan view of a heater embodying a rectangular shape;

FIG. 7 is a plan view of other embodiments of a heater;

FIG. 8 is an enlarged cross-sectional view of the heater of FIG. 7 taken along line 7-7;

FIG. 9 is a plan view of other embodiments of a heater;

FIG. 10 is an enlarged cross-sectional view of the heater of FIG. 9 taken along line 9-9;

FIG. 11 is a perspective view of a heater;

FIG. 12 is a top plan view of the heater of FIG. 11;

FIG. 13 is a front plan view of the heater of FIG. 11;

FIG. 14 is a side plan view of the heater of FIG. 11;

FIG. 15 is a perspective view of a heater;

FIG. 16 is a graphical representation depicting the temperature over time during multiple thermal cycle tests of the heater in FIG. 1 comprising the ceramic layer in accordance with aspects disclosed herein;

FIG. 17 is a graphical representation depicting the temperature over time during a first of two thermal cycle tests of the heater in FIG. 1 comprising the ceramic layer in accordance with aspects disclosed herein;

FIG. 18 is a graphical representation depicting the temperature over time during the ramp portion of a first thermal cycle test of the heater in FIG. 1 comprising the ceramic layer in accordance with aspects disclosed herein; and

FIG. 19 is a graphical representation depicting the electrical resistance at 1500° C. over time during a thermal cycle test of the heater in FIG. 1 comprising the ceramic layer in accordance with aspects disclosed herein.

The drawings are not to scale unless otherwise noted. The drawings are for the purpose of illustrating aspects and embodiments of the present invention and are not intended to limit the invention to those aspects illustrated therein. Aspects and embodiments of the present invention can be further understood with reference to the following detailed description.

### DETAILED DESCRIPTION

Reference will now be made in detail to exemplary embodiments of the present invention, examples of which are illustrated in the accompanying drawings. It is to be understood that other embodiments may be utilized and structural and functional changes may be made without departing from the respective scope of the invention. Moreover, features of the various embodiments may be combined or altered without departing from the scope of the invention. As such, the following description is presented by way of illustration only and should not limit in any way the various alternatives and modifications that may be made to the illustrated embodiments and still be within the spirit and scope of the invention.

Disclosed is a ceramic composite including (i) boron nitride (BN), and (ii) a conductive ceramic material for use in 2-D and 3-D heating element applications. The conductive ceramic material is selected from a boride, carbide, aluminide, or silicide of a metal. The conductive ceramic material may be considered intermetallic as it forms a compound of two metals (or a metal and a metalloid), e.g., titanium and boron, in the case of titanium boride materials. For purposes of this disclosure, the word intermetallic composite and ceramic composite can be used interchangeably.

The conductive ceramic material is selected from a boride, carbide, aluminide, and/or silicide of a metal. In one embodiment, the metal in the conductive ceramic material can be selected from Ti, Cu, Ni, Mg, Ta, Fe, Zr, Nb, Hf, V, W, Mo, Cr, etc. Examples of suitable aluminides include, but are not limited to, aluminides of Ti, Cu, Ni, Mg, Ta, Fe, etc. In one embodiment, the aluminide is chosen from TiAl, TiAl₃, Cu₂Al, NiAl, Ni₃Al, TaAl₃, TaAl, FeAl, Fe₃Al, Al₃Mg₂, etc. The conductive ceramic can also be a transition metal boride, carbide, or silicide. Examples of suitable borides, carbides, or silicides include borides, carbides, or silicides of Ti, Zr, Nb, Ta, Hf, V, W, Mo, Cr, etc. Examples of suitable borides include, but are not limited to, TiB₂, TiB, ZrB₂, NbB₂, TaB₂, HfB₂, VB₂, TaB, VB, etc. Examples of suitable carbides include, but are not limited to, TiC, TaC, WC, HfC, VC, MoC, TaC, Cr₇C₃, etc. It will be appreciated that the conductive ceramic material can include various ratios of the respective atoms as may be suitable for a particular purpose or intended use.

The ceramic composite may include mixtures or combinations of different conductive ceramic components (ii) as desired for a particular purpose or intended application. This may include a combination of different types of conductive ceramics, e.g., a boride and a carbide. This may also include different materials within a given class of conductive ceramic, e.g., two or more different types of borides, carbides, silicides, aluminides, etc.

In one embodiment, the composite material includes a titanium boride material. Titanium-boron materials include combinations of titanium and boron in various ratios. The most prevalent form is TiB₂. Titanium-boron materials as used herein also include other ratios including, but not limited TiB_{1.5-3.5}. The ceramic composite can be used in heater applications including high temperature vacuum processes without a protective coating. In addition to high temperature vacuum processes, the ceramic composite may also be used to replace atmospheric heating element alloy materials, such as molybdenum-silicide, nickel-chromium, and iron-chromium-aluminum, which are typically used in atmospheric conditions such as material processing and fuel cells as well as consumer electrical and electronic products such as e-cigarettes, medical equipment, home heating, automotive interior and engine applications, and the like.

The ratio of boron nitride to conductive ceramic material can be selected as desired for a particular purpose or intended use. In one embodiment, the (weight) ratio of boron nitride to conductive ceramic is selected from 10:90, 20:80, 30:70, 40:60, 50:50, 60:40, 70:30, 80:20, 90:10, etc.

In one embodiment, the composite material comprises from about 90% to about 10% by weight of boron nitride and about 10% to about 90% by weight of the conductive ceramic; from about 75% to about 25% by weight of boron nitride and from about 25% to about 75% by weight of the conductive ceramic; from about 60% to about 40% by weight of boron nitride and from about 40% to about 60% by weight of the conductive ceramic; or about 50% by weight of boron nitride and about 50% by weight of the conductive ceramic.

In one embodiment, the ceramic composite comprises boron nitride (BN) and titanium-boron material (e.g., diboride (TiB₂)). Any ratio of BN:TiB may be suitable for the heater including ratios of 10:90, 20:80, 30:70, 40:60, 50:50, 60:40, 70:30, 80:20, 90:10, etc. As previously discussed, another conductive ceramic may be used in place of TiB₂, such as a carbide, aluminide, and/or silicide to obtain the disclosed heater.

The ceramic composite is corrosion resistant against oxygen, nitrogen, hydrogen, ammonia, and moisture up to, for example, a temperature of 900° C., and offers increased corrosion resistance against molten or vapor metal, including aluminum. The ceramic composite is sufficiently rigid and does not require additional dielectric structural support. The ceramic composite is sufficiently fracture resistant to enable machining of intricate and complex patterns and designs with a high aspect ratio of the coil length to width or thickness. For instance, the aspect ratio may be as high as 100 within a square inch of heater surface. In some embodiments, the aspect ratio may range from 5-100 within a square inch, or about 6.5 cm², of heater surface.

The width or thickness of the resulting heating element comprising the ceramic composite can be as low as 1 mm and the coil length within a square inch can be as high as 100× the width or thickness. The ceramic composite and heating elements thereof can hold up against thermal and mechanical shock during installation and cleaning even at these smaller thicknesses. The width and thickness of the resulting heating element comprising the ceramic composite may also be greater than 1 mm, including 5 mm, 10 mm, 15 mm, 20 mm, etc. For example, the width and thickness of the heating elements may range from 0.5 mm to 50 mm.

The heater can be machined by any machining process to create any desired shape and orientation of the heating rungs, such as a serpentine pattern. In an embodiment, a method of manufacturing the heating rungs includes Computer Numerical Control (CNC) machining (cutting, lathing, milling, drilling) with diamond tooling. For example, the ceramic composite enables realization of high aspect ratio serpentine features as thin as 1 mm by CNC machining with diamond tooling. Other material removal techniques such as EDM, laser, water-jet, sand blasting, sawing, grinding and the like may also be used to machine heaters comprising the ceramic composite. In an embodiment, a method of manufacturing the ceramic composite includes hot pressing a blend of BN and the conductive ceramic, e.g., TiB, material with a sintering aid or binder. The sintering aid or binder may include calcium oxide, other metal oxides chosen from alkaline earth metals, aluminum and its associated compounds such as aluminum nitride, silicon and its associated compounds including silicon carbide or silicon nitride, carbon, metals or metals compounds of transition metals selected from tungsten, titanium, nickel, cobalt, iron, chromium, and the like, and a combination of two or more thereof.

The resistance per unit area of the heater may be tuned and manipulated by changing the aspect ratio per unit area and thickness. A serpentine pattern may achieve a high resistance per unit area. The ceramic composite has a high thermal conductivity and low Coefficient of Thermal Expansion (CTE), and a superior thermal shock resistance, for example, greater than 200° C./s or greater than 1000° C./min. The ceramic composite enables realization of high power flux density, such as greater than 10 W/cm², greater than 25 W/cm², or greater than 50 W/cm². After machining to a final shape of the heater or before, the heater comprising the ceramic composite may be outgassed or vacuum sintered at a temperature greater than 1800° C. to reduce outgassing and resistance changes during operation of the heater. As a result, the ceramic composite further enables a resistance per unit area to achieve a power density as high as 60 W/cm² with current under 40 amps at the operation temperature of about 1500° C.

In addition to vacuum outgassing, the heater including unreacted sintering aids and volatile compounds may be cleaned off by chemical leaching using inorganic or organic acids, bases, or solvents. Suitable acids include HF, acetic acid, and HCl; suitable bases include dilute NaOH and NH₄OH; and suitable solvents include hot methanol or water, or combination of two more of any of the foregoing. Chemical leaching may be used to reduce outgassing, and to tune or stabilize the resistivity of the heater material.

The 2-D or 3-D heaters employing the present ceramic composite can be coated or can be used in a naked or uncoated form. The conductive ceramic, e.g., TiB₂, provides electrical conductivity. BN provides structure in the ceramic composite that enables the ceramic composite to be machined. BN aids in the machinability of the ceramic composite because of its softness, aids in the thermal shock resistance of the ceramic composite because of its high thermal conductivity, has the ability to achieve high electrical resistance per unit area due to its high resistivity even at high temperatures of 1500° C. and superior chemical resistance complementing and/or supplementing chemical resistance of the conductive ceramic, e.g., TiB₂. BN can be used to increase or tune the resistivity. TiB₂ can be used to increase or tune the resistivity. Resistivity can also be tuned up or down by decreasing or increasing TiB₂ or by the addition of a boride, silicide, aluminide, or carbide of metals from subgroup 3, 4, 5, 6, etc. of the periodic table. Conductive oxide ceramics and glass may also be used for tuning resistivity. Resistance per unit area can be tuned by machining high aspect ratio features as detailed above and/or changing the resistivity of the base stock with the goal of achieving the desired power flux density at a desired current.

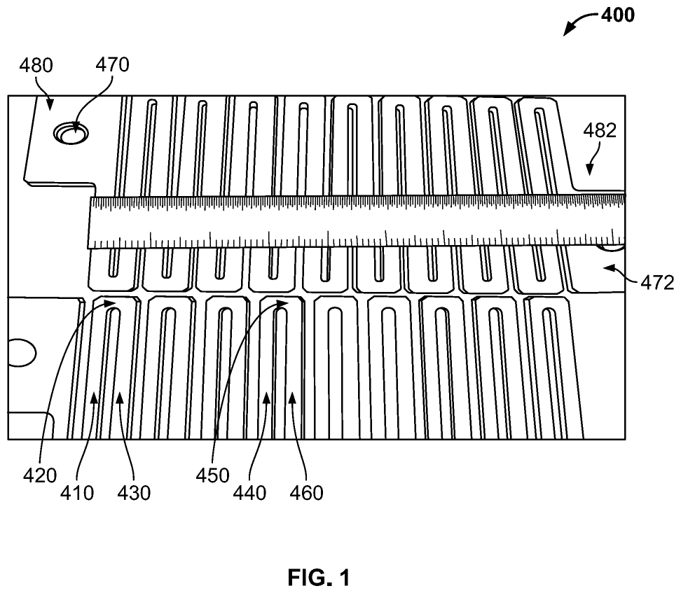

For example, the demonstration heaters shown in FIG. 1 were manufactured from AC6043 grade boron nitride composites commercially sold by Momentive Quartz and Ceramics, USA. Typical properties are as follows: density is about 2.78 gm/cm³, coefficient of thermal expansion (25-1500° C.) is about 7 ppm/C, modulus of elasticity is about 107 GPa, Flexural strength at 25° C. is about 89.6 Mpa and at 1500° C. is about 16.5 Mpa, thermal conductivity at 25° C. is about 70 W/mK and at 1500 C is about 43 W/mK, Rockwell Harness is about 123, and volume resistivity at 25° C. is in the range of about 400 to 1,600 MOC (micro-ohm-cm). As disclosed herein, the resistivity and other mechanical properties such as machinability can be tuned to ranges greater than above mentioned values by adjusting the ratio of TiB₂ and BN. Since the resistivity of hot pressed TiB₂ is very low, typically below 30 MOC at 25° C., even though materials made with greater than 95% TiB₂ may be electrically conductive, it may be difficult to achieve the resistance per unit area to deliver a power density as high as 60 W/cm² with current under 40 A. Further, materials with 95% or greater % of TiB₂ would be brittle to handle and difficult to machine even with a diamond tool as they tend to form cracks. In some embodiments, volume resistivity of from about 400 to about 10,000, or 400 to about 5,000 MOC may be achieved. These materials would also not be able withstand thermal shock as demonstrated by the heaters in FIG. 1. As a result, additional composite materials, such as BN, in order to tune the resistivity and other mechanical properties of the heater.

The ceramic composite may be used to provide a heater with any shape, orientation, and/or size as desired for a particular application or intended end use. The heater may be provided as a body having generally flat or uniform surfaces (having a substantially solid or block shape when viewed in cross-section), or the heater can be provided with a generally T-shape, generally C-shape, generally U-shape, generally I-shape, or generally H-shape cross-section. These structures may increase the resistance per unit area without compromising the structural strength of the high aspect ratio serpentine patterns of the heaters.

The heater may comprise a plurality of heating rungs. The heating rungs may be substantially horizontal or substantially vertical to a plane. The heating rungs may be substantially parallel or substantially perpendicular to a plane. The heater may include more than one zone or electrode path. A multi-zone heater may have a different power flux density at different locations, achieved by manipulating the aspect ratio of coil length to width or thickness in order to change the resistance per unit area. The at least two zones may each comprise a half of the heater or the at least two zones may be adjacent to one another along their lengths. Each heating rung may have the same width or differing widths, and a single heating rung may vary in its width across its length. While various exemplary heater shapes and structures are disclosed herein, it is noted that the heater structure is not limited to any particular shape or design, and any heater structure not disclosed may also be used.

FIG. 1 depicts a heating element 400 comprising a plurality of heating rungs in a 2-D orientation. The heating rungs may include upward heating rungs 410, 440, horizontal heating rungs 420, 450, and downward heating rungs 430, 460. As with all the described heater configurations, the heater comprises a ceramic composite including boron nitride (BN) and titanium diboride (TiB₂). There are terminal connecting holes 470, 472 at respective end portions 480, 482 of the heating element 400. The connecting holes 470, 472 are the points of attachment of an electrical power source which provides the electric current to the heating element 400.

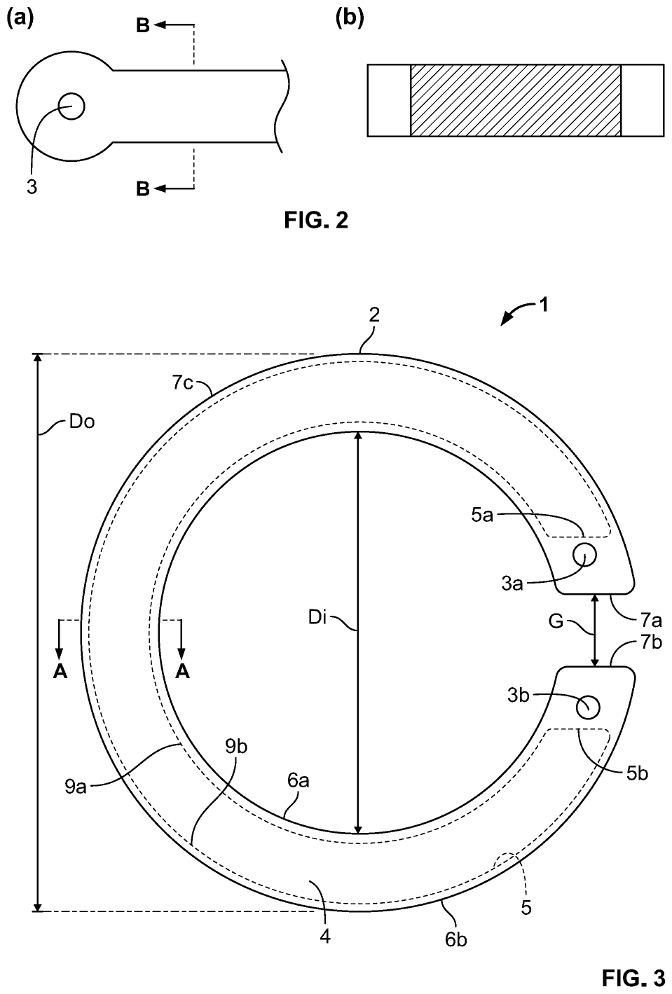

FIG. 2A depicts a heater comprising a rectangular heater body including a terminal end portion with a connecting hole, with a cross-section taken at position B-B shown in FIG. 2B. The terminal end portions have a widened and expanded shape at the end portion to decrease electric resistance.

FIG. 3 depicts a heater 1 comprising a C-shaped heater body 2. There are terminal connecting holes 3a, 3b at respective end portions of the C-shaped heater body 2, the opposing exterior end surfaces 7a and 7b being spaced apart so as to define a gap G therebetween. The connecting holes 3a and 3b are the points of attachment of an electrical power source which provides the electric current to the heater 1.

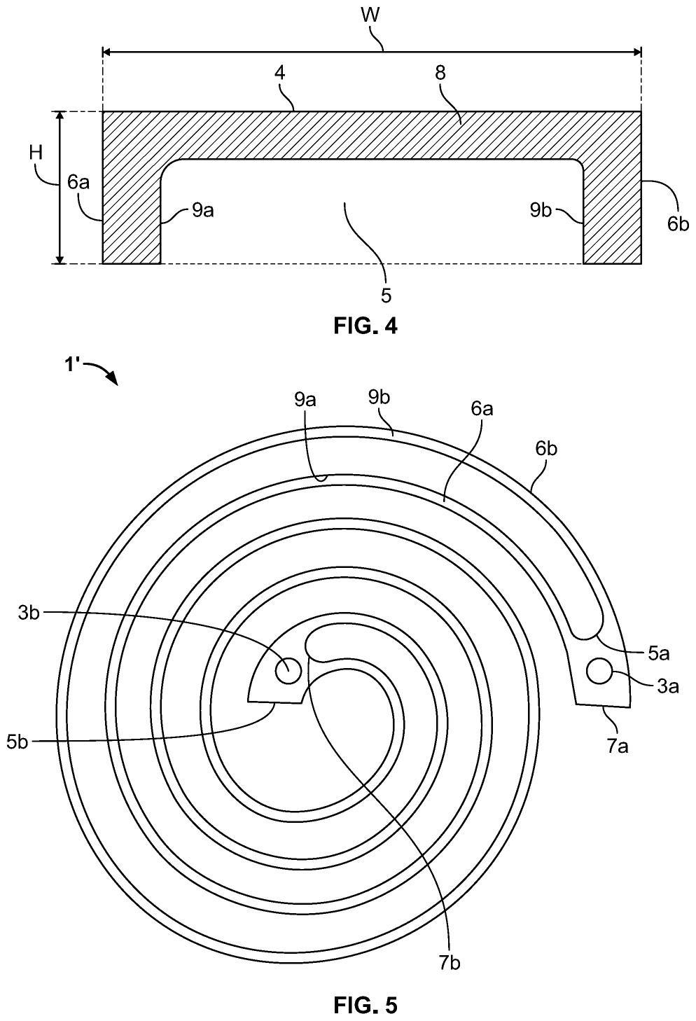

FIG. 4 is an enlarged cross-section taken along A-A in FIG. 3 where the heater body 2 has an upper horizontal wall 8 having a smooth and flat top heating surface 4 onto which an object to be heated, such as a wafer, is mounted directly or indirectly via a susceptor, etc. A center portion of the underside of the heater body 2 is recessed to form an elongated groove or recess 5 between a pair of opposite vertical side walls or ribs 6a, 6b, said side walls having inner surfaces 9a and 9b which at least partially define the recess 5. The recess 5 and side walls 6a, 6b extend in an arcuate linear direction of the C-shaped heater body 2 so as to provide an inverted U-shaped cross section along a middle portion 7c of the heater, but not at the end portions of the heater body. In particular, the recess 5 terminates at end surfaces 5a and 5b, the portion of the body between recess end surfaces 5a and 5b and the respective exterior end surfaces 1a and 1b defining the respective end portions of the body. The body 2 has the same width W along its entire length, including both end portions and the middle portion 7c therebetween. The full thickness of the body 2 at the end portions maintains a relatively cooler temperature at the end portions but the uniform width of the body improves control of the heat distribution pattern. The middle portion 7c of the body has a reduced cross sectional area available for electrical conduction thereby increasing, and improving heater resistance.

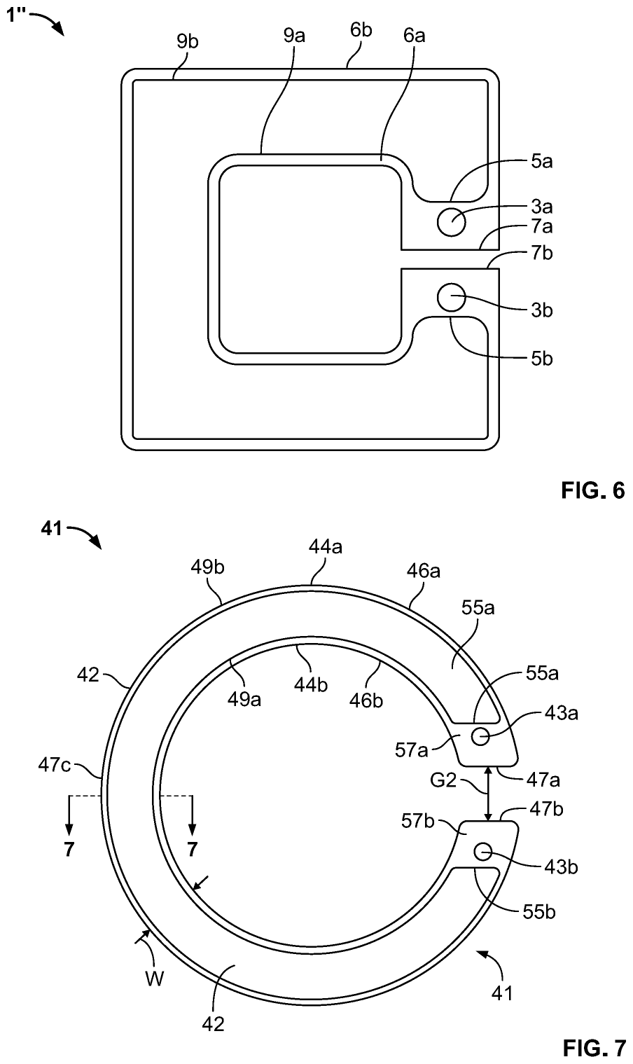

The heater body can be designed into a spiral heat pattern, such as heater 1′ shown in FIG. 5, and as shown in Japanese patent publication No. 2005-86117(A). In some applications, the heater body is formed into a square or rectangular pattern, such as heater 1″ shown in FIG. 6. These and other heater shapes are also within the scope of the present invention, such as a serpentine or helical pattern.

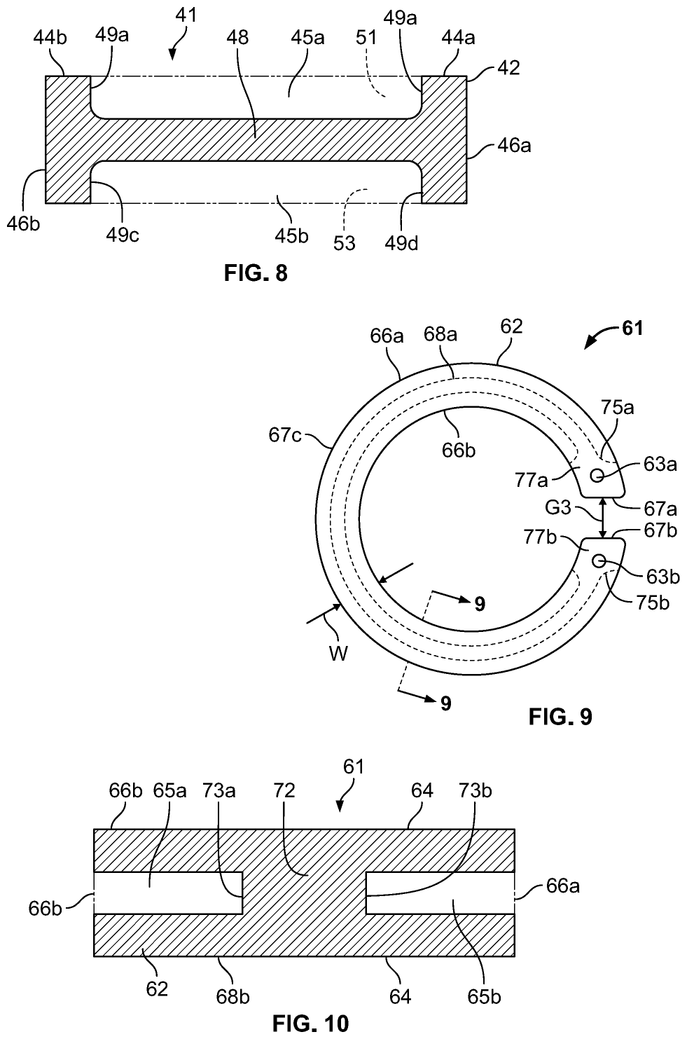

FIGS. 7 and 8 show an embodiment of a heater. Heater 41 may include a generally a C-shaped heater body 42. The heater body 42 may include terminal connecting holes 43a, 43b, which may be located at respective end portions of the C-shaped heater body 42. The opposing exterior end surfaces 47a and 47b may be generally spaced apart so as to define a gap G2 between such. The connecting holes 43a and 43b may be the points of attachment of an electrical power source (not shown) that may provide the electric current to the heater 41. By way of a non-limiting example, in these embodiments the heater body 42 may have a cross-sectional shape such as shown in FIG. 8. As shown in FIG. 8 the heater body 42 may have a generally horizontally symmetrical cross-sectional shape, such as by way of a non-limiting example, a generally H-shaped cross-sectional shape. In these embodiments, the heater body 42 may include a generally centrally positioned and generally horizontal wall 48.

In these embodiments, a top and bottom central portion 51, 53 of the heater body 42 may be recessed to form a pair of elongated grooves or recesses 45a, 45b between a pair of opposite vertical side walls or ribs 46a, 46b. The recesses 45a, 45b may be positioned on both the top and bottom portion of the heater body 42. The side walls 46a, 46b may each include inner surfaces 49a, 49b, 49c and 49d, which may at least partially define the recesses 45a, 45b. The recesses 45a, 45b and side walls 46a, 46b may extend in an arcuate linear direction of the generally C-shaped heater body 42. This may provide a generally H-shaped cross sectional shape along at least a middle portion 47c of the heater 41. The vertical side walls 46a, 46b may each possess a generally smooth and flat heating surface 44a, 44b, respectively onto which an object to be heated, such as a wafer, may be mounted directly or indirectly via a susceptor, etc.

The general H-shaped cross-sectional shape, however, may not extend to the end portions 47a, 47b of the heater body 42. By way of a non-limiting example, the recesses 45a, 45b may generally terminate at end surfaces 55a and 55b, the portion of the body 42 between recess end surfaces 55a and 55b and the respective exterior end surfaces 47a and 47b may define the respective end portions 57a, 57b of the body 42. As indicated above, the body 42 may have width W along its entire length, including both end portions and the middle portion 47c therebetween. The width W may be generally consistent along an entire length of the body 42.

Embodiments of a heater are shown in FIGS. 9 and 10. Heater 61 may include a generally a C-shaped heater body 62. The heater body 62 may include terminal connecting holes 63a, 63b, which may be located at respective end portions of the C-shaped heater body 62. The opposing exterior end surfaces 67a and 67b may be generally spaced apart so as to define a gap G3 between such. The connecting holes 63a and 63b may be the points of attachment of an electrical power source (not shown) that may provide the electric current to the heater 61. By way of a non-limiting example, in these embodiments the heater body 62 may have a cross-sectional shape such as shown in FIG. 10.

As shown in FIG. 10 the heater body 62 may have a generally symmetrical cross-sectional shape, such as by way of a non-limiting example, a generally I-shaped cross-sectional shape. Still further, the heater body 62 may have a generally horizontally symmetrical cross-sectional shape. In these embodiments, the heater body 62 may include a pair of generally horizontal walls 68a and 68b. The first wall 68a may be on the top portion of the body 62 and the second wall 68b may be on the bottom portion of the body 62. Either or both of the horizontal walls 68a and 68b may possess a generally smooth and flat heating surface 64 onto which an object to be heated, such as a wafer, may be mounted directly or indirectly via a susceptor, etc.

In these embodiments, a pair of side walls 66a, 66b of the heater body 62 may be recessed to form a pair of elongated grooves or recesses 65a, 65b. By way of a non-limiting example, the recesses 65a, 65b may be formed in the pair of opposite vertical side walls 66a, 66b in any appropriate manner. Once the recesses 65a, 65b may be formed in the vertical side walls 66a, 66b, a generally central wall 72 may be formed in the heater body 62. This may define the generally I-shaped cross-sectional heater body 42. Side walls 73a, 73b of the central wall 72 may define the recesses 65a, 65b.

The recesses 65a, 65b and side walls 73a, 73b may extend in an arcuate linear direction of the generally C-shaped heater body 62 so as to provide a generally I-shaped cross sectional shape along at least a middle portion 67c of the heater 61. The generally I-shaped cross-sectional shape, however, may not extend to the end portions 75a, 75b of the heater body 62. By way of a non-limiting example, the recess 65a, 65b may terminate at end surfaces 75a and 75b. The portion of the body 62 between recess end surfaces 75a and 75b and the respective exterior end surfaces 67a and 67b may define the respective end portions 77a, 77b of the body 62.

As indicated above, the body 62 may have width W along its entire length, including both end portions 77a, 77b and the middle portion 67c therebetween. The width W may be generally consistent along an entire length of the body 62. While the exemplary dimensions are described above, the present teachings are not limited to these specific dimensions. The dimensions are merely exemplary and may be altered as required.

The heater may also be provided with a 3-D structure, for example to provide heating in a radial direction. In an embodiment, the heater comprises a body having a configuration defining a predetermined path defining a plurality of heating rungs. The heater can be an integral body where the path can be a continuous path comprising a plurality of heating rungs. In one embodiment, the heater comprises a body comprising two halves connected in series, where each half comprises a plurality of heating rungs in a predetermined configuration.

In accordance with aspects of the invention, the heater body comprises an upper surface, a lower surface, and the body has a configuration defining a predetermined path defining a plurality of heating rungs, where the heating rungs have a major portion that is oriented substantially parallel to the upper surface of the body. In one embodiment, the body comprises two halves connected in series, where each half has a configuration defining a predetermined path defining a plurality of heating rungs, where the heating rungs have a major portion oriented substantially parallel to the upper surface of the body.

By providing a configuration with the major portion of the heating rungs oriented substantially parallel to the upper surface of the body, the heater body has a larger cross-sectional area that allows the thermal expansion to be spread over the entire length of the heating rungs, which has been found to reduce the stress concentration over the heater body.

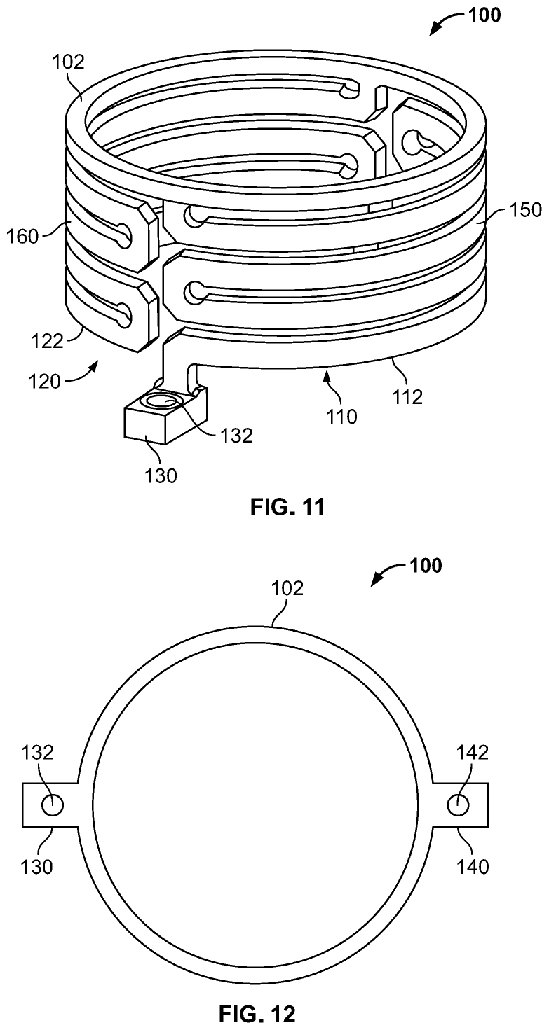

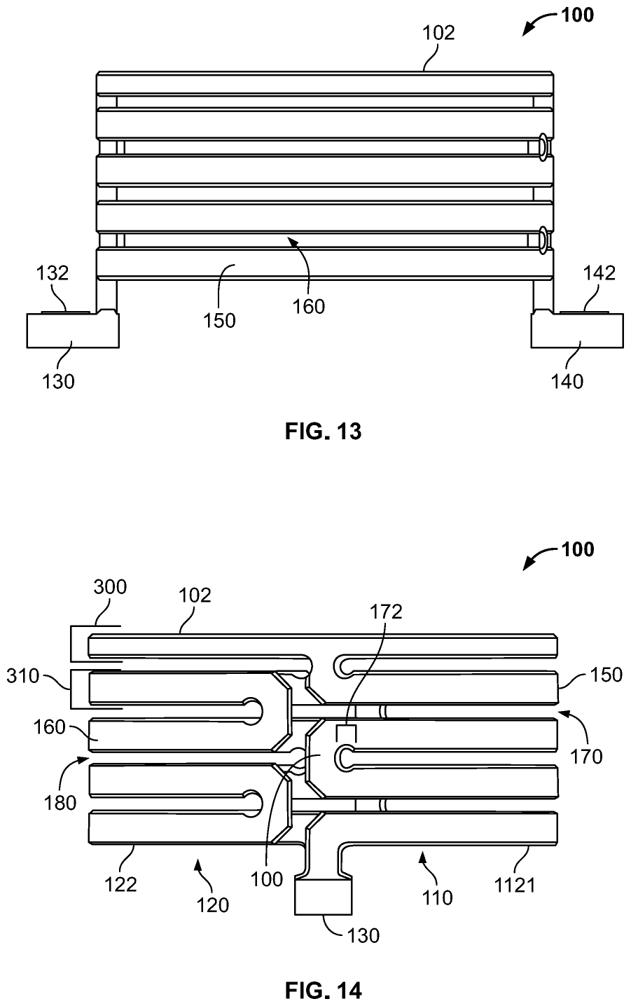

FIGS. 11-14 illustrate an embodiment in accordance with aspects of the present technology. The heater 100 comprises a first half 110 and a second half 120. The first half extends from a terminal 130, and the second half extends from a terminal 140. The terminals 130 and 140 include terminal connecting holes 132 and 142, respectively, which are points of attachment for an electrical power source to provide electrical current to the heater.

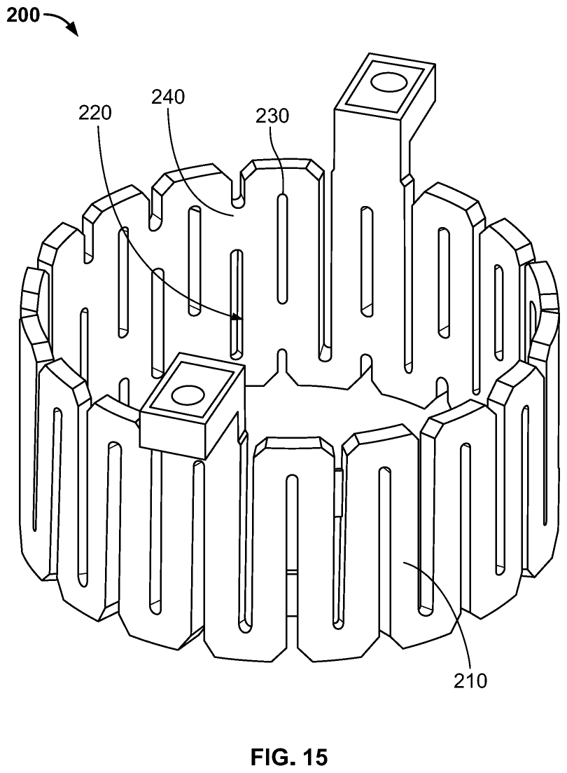

The heater 100 is illustrated as a cylindrical body comprising an upper surface 102. Each half, 110 and 120, defines a bottom surface 112 and 122, respectively. Each half of the heater body 100 is machined into a predetermined path defining a plurality of heater rungs 150 and 160. In FIGS. 11-14, the paths are provided in a serpentine arrangement with a major portion of the heating rung 150, 160 (or path) being oriented parallel with the upper surface of the heater, and a minor portion defining the turn in the path. As illustrated in FIGS. 11, 12, and 14, the respective serpentine pattern extends linearly and vertically from each terminal and then turns to form the major portions oriented horizontal and parallel to the plane of the upper surface of the heater. As shown in FIG. 15, a major portion of the rungs may also be oriented vertically.

It will be appreciated that the electrical flow path of the body may form any appropriate pattern, including, but not limited to, a spiral pattern, a serpentine pattern, a helical pattern, a zigzag pattern, a continuous labyrinthine pattern, a spirally coiled pattern, a swirled pattern or a randomly convoluted pattern. Additionally, the heater body can be provided in any suitable shape as desired for a particular purpose or intended application.

In the embodiment of FIG. 14, the width 300 of the uppermost heating rung at the top of the upper surface of the body is narrower than the width 310 of the other heating rungs. In one embodiment, the width 300 is less than or equal to half the width 310.

As illustrated, there is a gap or space 170, 180 between successive heating rungs. In one embodiment, the gap can be uniform between successive heating rungs including at the turn. In another embodiment, the gap defined near the turn of the serpentine path can be provided such that it is sized to have one or more dimensions larger than a dimension of the gap between the major portions of the heating rungs. For example, the height or width of the gap near the turn can be larger than the gap between the major portions of the heating rungs. As shown in FIGS. 11, 13, and 14, the gap 172 near the turn of the path can be provided with a geometric shape including, but not limited to, a rectangle, a square, a circle, a triangle, a pentagon, a hexagon, a heptagon, etc. The larger gaps 172 can taper or lead to the gap between the heating rungs. As illustrated in FIGS. 11, 13, and 14, the gap 172 near the turn of the serpentine path is circular to provide a “keyhole” gap. The present design with the relatively large cross sectional area provided by arranging the heating rungs with the major portion oriented horizontally to the plane of the upper surface of the heater allows for the inclusion of the larger gap near the turn of the serpentine path. The larger gaps near the turns can further reduce the thermal stress of the heater.

The width of the heating rung is not particularly limited. In one embodiment each heating rung may have substantially the same width. In another embodiment, the width of two or more heating rungs can be different or varied from one another. For example, the width of at least one heating rung may be narrower than the width of at least one other heating rung. In one embodiment, the uppermost heating rung at the top of the upper surface of the body may be narrower than at least one other heating rung. For example, the width of the uppermost heating rung may be narrower than the width of the heating rung directly below it. The width of the uppermost rung may be narrower than each of the other rungs, and each of the other rungs may have the same or different widths. In one embodiment, the width of each heating rung is different and decreases from the lowest rung to the uppermost rung. In another embodiment, the width of the uppermost heating rung may be less than or equal to half the width of at least one other heating rung. For example, the width of the uppermost heating rung may be less than or equal to half the width of the heating rung directly below.

In one embodiment one rung has a width that is about 0.5 times the width of another rung; about 0.4 times the width; about 0.3 times the width; about 0.2 times the width; even about 0.1 times the width of another rung. In another embodiment, one rung has a width that is about 0.05 to about 0.5 times the width of another rung; about 0.1 to about 0.4 times the width; even about 0.15 times to about 0.3 times the width of another rung.

Varying the width of the heating rungs has been found to impact the power density. For example, decreasing the width of the uppermost heating rung relative to the width of the other heating rungs increases the power density at the top of the heater. When the width of the uppermost heating rung is less than or equal to half the width of the heating rung directly below it, there is an increase in the power density at the top of the heater. Generally, it has been found that the change in power density can be calculated using the below formula:

width ratio=1/2\sqrt{power density ratio}

Thus, a width ratio of about 0.466 results in a power density ratio of 1.15, which means that the power density is increased by about 15%. Thus, varying the width of the heating rungs allows for controlling the power density of the heater.

### EXAMPLES

FIG. 1 depicts an embodiment of a heating element 400 comprising a plurality of heating rungs in a 2-D orientation. The heating rungs may include upward heating rungs 410, 440, horizontal heating rungs 420, 450, and downward heating rungs 430, 460. The heating element 400 comprises an ceramic composite including boron nitride (BN) and titanium diboride (TiB₂) and each heating rung 410, 420, 430, 440, 450, 460, etc. may have a thickness of as low as 1 mm. There are terminal connecting holes 470, 472 at respective end portions 480, 482 of the heating element 400. The connecting holes 470, 472 are the points of attachment of an electrical power source which provides the electric current to the heating element 400.

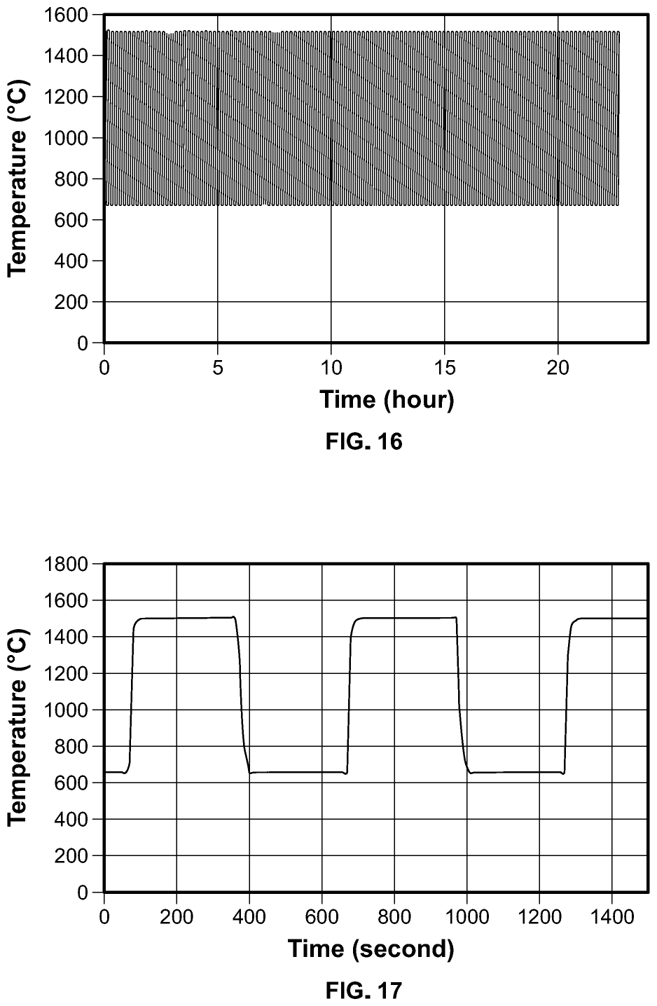

FIG. 16 is a graphical representation depicting the temperature over time during multiple thermal cycle tests of the heater in FIG. 1 comprising the ceramic layer. Over 100 thermal cycle tests were completed over a course of 24 hours where a cycle is about 3.6 kW for 5 minutes and 0 kW for 5 minutes.

FIG. 17 is a graphical representation depicting the temperature over time during the first two thermal cycle tests of the heater in FIG. 1 comprising the ceramic layer.

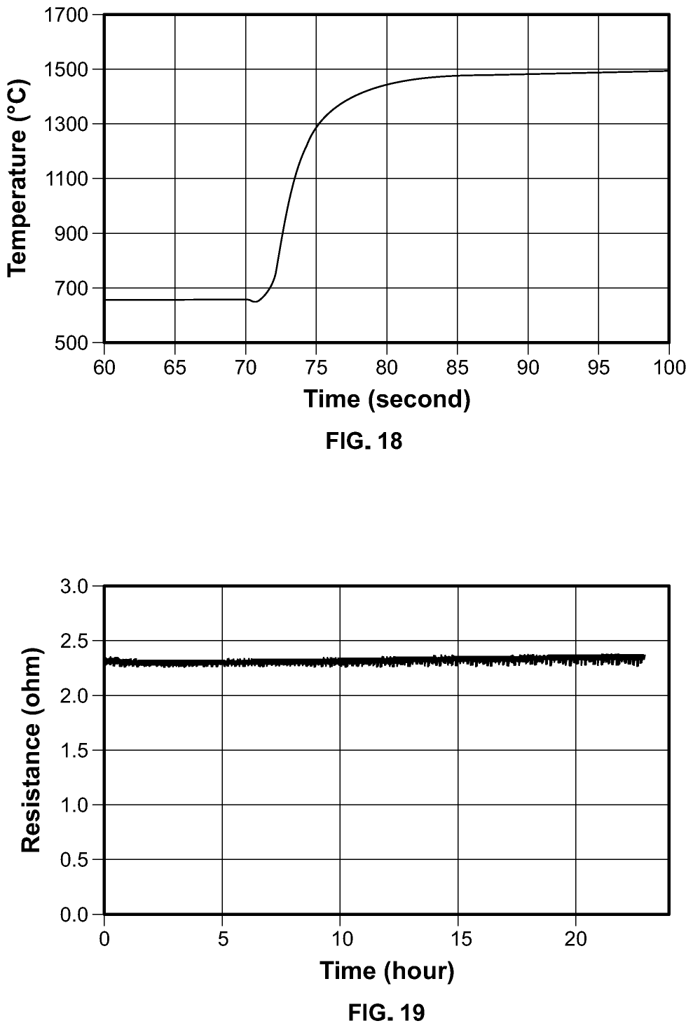

FIG. 18 is a graphical representation depicting the temperature over time during the ramp portion of the first thermal cycle test of the heater in FIG. 1 comprising the ceramic layer. As illustrated, the heater can withstand greater than 200° C./s ramp up.

FIG. 19 is a graphical representation depicting the resistance over time during the thermal cycle test of the heater in FIG. 1 comprising the ceramic layer. As shown, the electrical resistance of the heater at 1500° C. is stable over the 100 thermal cycle tests at a high temperature, demonstrating the thermal and vacuum stability of electrical resistance.

Although a standalone heater with serpentine pattern is described herein, the heater may be used in an embedded format. For example, the heater can be embedded in an electrostatic chuck with hot pressed AlN, alumina, or BN. Heaters can also be used detachably inlaid in a surrounding dielectric to prevent direct contact with substrate or wafer. In these applications, the CTE of the serpentine may be tuned to match the surrounding dielectric materials by adjusting the ratio of TiB₂, BN, sintering agents, and the hot pressing process. In an embedded format, the serpentine heater can also be used to deliver chucking voltage in an electrostatic chuck.

Although the embodiments of the present invention have been illustrated in the accompanying drawings and described in the foregoing detailed description, it is to be understood that the present invention is not to be limited to just the embodiments disclosed, but that the invention described herein is capable of numerous rearrangements, modifications and substitutions without departing from the scope of the claims hereafter. The claims as follows are intended to include all modifications and alterations insofar as they come within the scope of the claims or the equivalent thereof.

1. A heater comprising:
a heater body comprising a ceramic composite composition including (i) boron nitride, and (ii) a conductive ceramic material.

2. The heater of claim 1, wherein the conductive ceramic material is selected from a metal boride, a metal nitride, a metal silicide, a metal carbide, a metal aluminide, or a combination of two or more thereof.

3. The heater of claim 1, wherein the conductive ceramic material comprises a metal selected from the group of Ti, Cu, Ni, Mg, Ta, Fe, Zr, Nb, Hf, V, W, Mo, Cr, or a combination of two or more thereof.

4. The heater of claim 1, wherein the conductive ceramic material is a titanium-boron material.

5. The heater of claim 4, wherein the titanium-boron material is of the formula TiB_{1.5-3.5}.

6. The heater of claim 4, wherein the titanium-boron material is TiB₂.

7. The heater of claim 1 wherein the ceramic composite comprise from about 10% to about 90% by weight of the boron nitride and from about 10% to about 90% of the conductive ceramic material.

8. A heater of claim 1, wherein the composite contains from about 10% to about 90% by weight of TiB₂ and from about 10% to about 90% by weight of BN.

9. A heater of claim 1, wherein the composite contains TiB₂ ranging from 40% to 50%.

10. The heater of claim 1, wherein the heater body comprises:
at least one heating surface, the heating surface being generally smooth and generally flat;
a recess formed in the body, at least a portion of the body having a cross-sectional shape selected from the group consisting of: generally T-shape, generally C-shape, generally U-shape, generally I-shape, and generally H-shape; and
wherein the cross-sectional shape extends along at least a portion of the body.

11. The heater of claim 1, wherein the heater body comprises:
an upper surface;
a lower surface; and
a configuration defining a predetermined path defining a plurality of heating rungs, wherein a major portion of each heating rung is oriented substantially parallel to the upper surface.

12. The heater of claim 11, wherein the body further comprises two halves connected in series, where each half has a configuration defining a predetermined path defining a plurality of heating rungs, wherein a major portion of each heating rung is oriented substantially parallel to the upper surface.

13. The heater of claim 12, wherein the body is a cylindrical body.

14. The heater of claim 12, wherein each heating rung has substantially the same width.

15. The heater of claim 12, wherein the width of at least one heating rung is narrower than the width of at least one other heating rung.

16. The heater of claim 12, wherein the width of an uppermost heating rung at the top of the upper surface of the body is narrower than at least one other heating rung.

17. The heater of claim 12, wherein the width of an uppermost heating rung at the top of the upper surface of the body is less than or equal to half the width of at least one other heating rung.

18. The heater of claim 11, wherein each heating rung forms a 2D serpentine pattern and/or 3D helical pattern.

19. The heater of claim 1, wherein the heater has an aspect ratio in the range of 5-100 per square inch of heater surface.

20. The heater of claim 1, wherein the composite material has a resistivity greater than 30 MOC (micro ohm cm) at 25° C.

21. The heater of claim 1, wherein the composite material has a resistivity of 300 MOC to 1600 MOC at 25° C.

22. The heater of claim 1, wherein the composite material has a resistivity of 1600 MOC to 10000 MOC at 25° C.

23. The heater of claim 1, wherein the width or thickness of the heating rung is as low as 1 mm and the coil length within square inch of heater surface is up to 100× the width or thickness.

24. The heater of claim 1, where the resistance per unit area allows the heater to operate at a power flux density as high as 60 w/cm² with a current under 40 amps at an operation temperature of about 1500° C.

25. The heater of claim 1, wherein the heater includes a first region having a first aspect ratio and a second region having a second aspect ratio, where the first aspect ratio is different from the second aspect ratio.

26. The heater of claim 1, wherein the heater includes a first region having a first power density and a second region having a second power density, where the first power density is different from the second power density.

27. A heater of claim 1, wherein the heater body comprises a sintering aid or binder selected from an alkaline earth metal oxide, aluminum nitride, silicon nitride, silicon carbide, carbon, metals or metal compounds of transition metals selected from tungsten, titanium, nickel, cobalt, iron, and chromium, or a combination of two or more thereof.

28. The heater of claim 1, wherein the heater is a standalone heater or an embedded heater in a dielectric.
